(19) United States
(12) Patent Application Publication
(10) Pub. No.: US 2010/0071422 A1
(43) Pub. Date: Mar. 25, 2010

(54) ANTI-THEFT DEVICE AND METHOD FOR FUEL DISPENSERS

(75) Inventors: Terence Brian Kiest, Highland, IN (US); Michael Steven Kiest, Porter, IN (US); Michael Anthony Hawley, Highland, IN (US)

Correspondence Address: HARTMAN & HARTMAN, P.C., 552 EAST 700 NORTH, VALPARAISO, IN, 46383, US

(73) Assignee: NORTHERN INDIANA MECHANICAL, Gary, IN (US)

(21) Appl. No.: 12/566,035

(22) Filed: Sep. 24, 2009

Related U.S. Application Data
(60) Provisional application No. 61/099,748, filed on Sep. 24, 2008.

(51) Int. Cl. E05B 73/00

(52) U.S. Cl. 70/14

(57) ABSTRACT

An anti-theft device and method for securing and preventing access to components within an interior of a fuel dispenser cabinet having an access door located on one side of the cabinet. The device includes structure for securing the anti-theft device to the periphery of the cabinet, structure for preventing the anti-theft device from being laterally and vertically removed from the cabinet, and a releasable assembly for selectively allowing and preventing access to the interior of the cabinet through the door.

### CROSS REFERENCE TO RELATED APPLICATIONS

This application claims the benefit of U.S. Provisional Application No. 61/099,748, filed Sep. 24, 2008, the contents of which are incorporated herein by reference.

### BACKGROUND OF THE INVENTION

The present invention generally relates to devices capable of securing and preventing access to the interior components of fuel dispensers, for example, of the types found at gas stations and especially the large commercial plazas frequented by interstate travelers.

Fuel dispensers generally comprise a cabinet that defines a closed interior containing components that deliver and meter the fuel being dispensed, and display the amount and cost of the dispensed fuel. A door is typically provided through which the interior of the dispenser can be accessed for repairs and maintenance. If access can be gained to the interior of the dispenser, an individual can obtain fuel illegally by damaging the dispenser metering components, and particularly by removing or damaging a pulser within the dispenser that calculates the fuel sale from the dispenser. Consequently, devices referred to as pulser guards have been installed within fuel dispensers to physically protect the pulser. However, pulser guards are ineffective if an individual realizes that, by gaining access to the interior of the dispenser through the door, they can tamper with or sufficiently damage the pulser guard so that the pulser can still be removed or damaged.

### BRIEF DESCRIPTION OF THE INVENTION

The present invention provides an anti-theft device and method for securing and preventing access to components within an interior of a fuel dispenser cabinet having upper and lower margins, sides defining a periphery of the cabinet, and an access door located in one of the sides of the cabinet.

According to a first aspect of the invention, the anti-theft device includes means for securing the anti-theft device to the periphery of the cabinet, means for preventing the anti-theft device from being laterally and vertically removed from the cabinet, and releasable means for selectively allowing and preventing access to the interior of the cabinet through the door located on a side of the cabinet. In a preferred embodiment, the anti-theft device is secured and prevented from being removed by configuring the device to comprise first and second frame units, each comprising a pair of legs and at least a first cross-member joined and oriented transverse to the pair of legs, and at least a second cross-member that couples the first and second frame units together. Furthermore, the releasable means preferably comprises the second cross-member, a first end of which is pivotably coupled to the first frame unit and a second end is releasably coupled to the second frame unit. Finally, means is provided for locking the second end of the second cross-member to the second frame unit.

According to another aspect of the invention, the method entails securing the anti-theft device to the periphery of the cabinet, preventing the anti-theft device from being laterally and vertically removed from the cabinet, and selectively allowing and preventing access to the interior of the cabinet through the door located on the side of the cabinet.

In view of the above, the invention is capable of securing and preventing access to the interior components of fuel dispensers, for example, of the types found at gas stations and especially the large commercial plazas frequented by interstate travelers, so that individuals cannot gain access to the interior of the dispenser and remove or damage the pulser or other metering components within the dispenser for the purpose of illegally obtaining fuel from the dispenser.

Other aspects and advantages of this invention will be better appreciated from the following detailed description.

### BRIEF DESCRIPTION OF THE DRAWINGS

FIGS. 1 and 2 are perspective and side views, respectively, of an anti-theft device installed on a fuel dispenser in accordance with an embodiment of this invention.

FIGS. 3 and 4 are front and top views, respectively, of the anti-theft device of FIGS. 1 and 2.

### DETAILED DESCRIPTION OF THE INVENTION

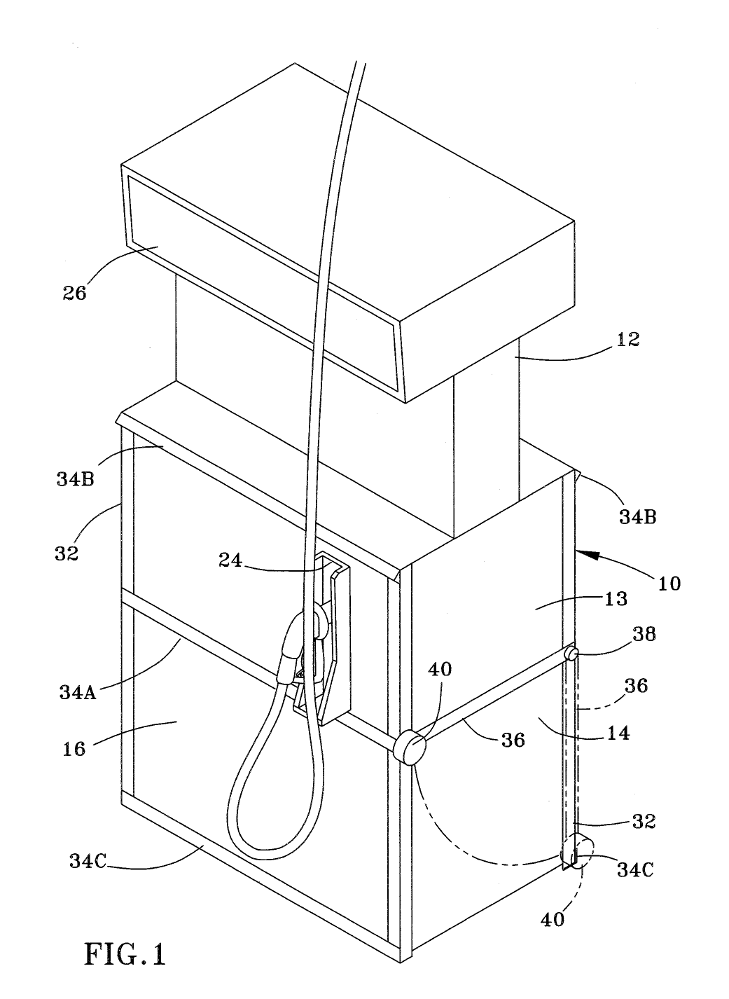

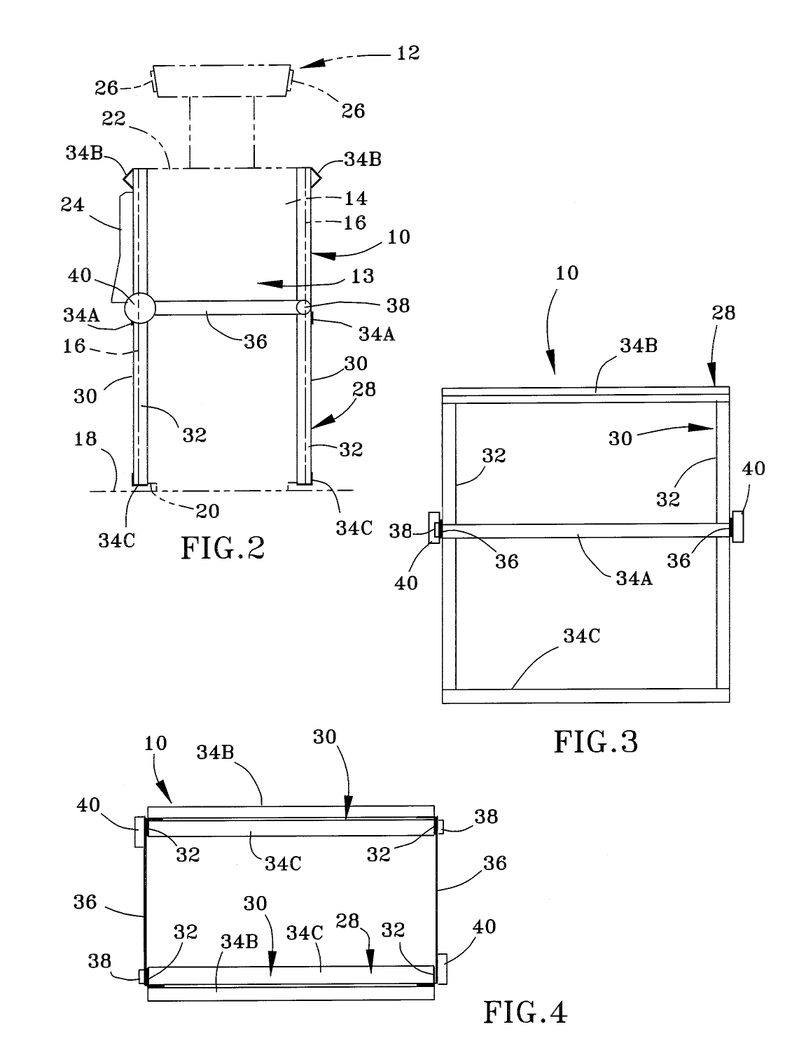

FIGS. 1 through 4 depict an anti-theft device 10 adapted for protecting interior components of a fuel dispenser 12, and particularly the removal of or damage to the pulser (not shown) or any other metering components within a cabinet 13 of the dispenser 12. To facilitate the description of the device 10, the terms “vertical,” “horizontal,” “front,” “rear,” “side,” “upper,” “lower,” “above,” “below,” “right” and “left” are used in reference to the drawings and the installation of the dispenser 12 depicted in the drawings. FIGS. 1 and 2 depict the dispenser 12 as a generic fuel dispenser, and it should be understood that installations on various types of fuel dispensers are also within the scope of the invention.

Shown in FIGS. 1 and 2, the dispenser cabinet 13 is generally configured to define an outer periphery formed by outer wall panels 14 and one or more doors 16 that allow access to the interior of the cabinet 13. One door 16 is visible in FIG. 1 on one of the wider sides of the cabinet 13, while a second door 16 is typically located on the opposite wider side of the cabinet 13. The doors 16 may be configured as panels that can be completely removed from the cabinet 13 or equipped with hinges to open by swinging out and away from the cabinet 13, though other configurations are also possible and within the scope of the invention. The two narrower sides of the cabinet 13 are represented as defined by panels 14 that are not configured as doors or otherwise removable, but instead are permanently attached with fasteners (not shown) or other means to the underlying framework of the cabinet 13. Other configurations for the cabinet 13, including different quantities and locations for the panels 14 and doors 16, are also possible and within the scope of the invention. The dispenser 12 is adapted for being secured to a foundation 18, and the lower extents of the wall panels 14 define a lower margin 20 of the cabinet 13 spaced above the foundation 18. In a similar manner, the upper extents of the wall panels 14 also define an upper margin 22 of the cabinet 13.

As evident from the Figures, the anti-theft device 10 comprises a frame assembly 28 sized and configured to surround the outer periphery of the fuel cabinet 13 in a manner that secures the outer wall panels 14 and doors 16, thus preventing the removal of the panels 14 and doors 16 and preventing access to the interior of the cabinet 13. The frame assembly 28 is represented as comprising two substantially identical frame units 30 that are installed on opposite sides of the cabinet 13, preferably on the wider sides of the cabinet 13 where the fuel nozzle carriages 24 (one of which is shown) and dispenser displays 26 are located in FIGS. 1 and 2. Each frame unit 30 is shown as comprising a pair of vertical legs 32 and three cross-members 34A, 34B and 34C. The quantities and locations of the legs 32 and cross-members 34A-C can differ from what is shown in the Figures. The legs 32 and the upper and lower cross-members 34B and 34C are represented as being constructed of angle iron (or any other suitable material), and the remaining cross-members 34A are represented as being formed of flatstock. The choice of forming the legs 32 and cross-members 34A-C from angle or flatstock will depend on the particular construction of the cabinet 13, though certain advantages will be described below for the legs 32 and cross-members 34A-C when formed of either angle or flat stock. The cross-members 34A-C are preferably joined by welding (or any other suitable joining or attachment technique) to the legs 32, such that each frame unit 30 has a solid one-piece construction that cannot be disassembled without cutting the legs 32 and cross-members 34A-C.

The frame units 30 are shown as being connected together and secured to the cabinet 13 with additional cross-members 36 located at each of the narrower sides of the cabinet 13. As evident from FIGS. 1 and 2, the frame units 30 are assembled onto the cabinet 13 so that the cross-members 34A-C extend across the wider sides of the cabinet 13, and at least the cross-members 34B extend across the doors 16 located on the wider sides of the cabinet 13 to effectively prevent their opening. FIGS. 1, 2 and 3 depict each cross-member 36 as being formed of flatstock and configured as a locking cross-member. In the embodiment shown, each locking cross-member 36 is pivotally attached with a bolt 38 to a leg 32 of one of the frame units 30, such that each unit 30 has a locking cross-member 36 attached thereto. At its end opposite the bolt 38, each locking cross-member 36 is equipped with a locking device 40 to enable the locking cross-member 36 to be locked to a leg 32 of the other frame unit 30, thus preventing the frame assembly 28 from being laterally removed from the cabinet 13. The locking mechanism 40 can be of any suitable type, including but not limited to a padlock whose shackle passes through alignable holes (not shown) on the locking cross-member 36 and on a bracket (not shown) attached to the leg 32 to which the cross-member 36 is locked with the mechanism 40. Access to the interior of the cabinet 13 is achieved by unlocking the locking mechanisms 40 to enable the locking cross-members 36 to be uncoupled from the legs 32, and then separating the frame units 30 to permit opening of either cabinet door 16 held closed by either unit 30. As such, without a key, combination, etc., for unlocking the locking mechanism 40, the interior of the cabinet 13 cannot be accessed and fuel cannot be illegally obtained by damaging the dispenser metering components within the dispenser cabinet 13.

As evident from FIGS. 1 and 2, lifting of the frame assembly 28 off the cabinet 13 is prevented as a result of the cross-members 34A extending across the wider sides of the cabinet 13 directly below the fuel nozzle carriages 24 (one of which is shown). Optionally, lifting of the frame assembly 28 can also be prevented by engaging the lower margin 20 of the cabinet 13 with the lower cross-members 34C, as shown in FIG. 2. The angle stock used to form the legs 32 also cover the vertical corners of the cabinet 13 to further assist in preventing the removal of the panels 14 and doors 16 of the cabinet 13.

While the invention has been described in terms of a specific embodiment, it is apparent that other forms could be adopted by one skilled in the art. For example, the functions of certain components of the anti-theft device 10 could be performed by components of different construction but capable of a similar (though not necessarily equivalent) function, the frame assembly 28 and its components could differ in appearance and construction from the embodiment shown in the figures, and appropriate materials could be substituted for those noted. Accordingly, the scope of the invention is to be limited only by the following claims.

1. An anti-theft device adapted to secure and prevent access to components within an interior of a fuel dispenser cabinet having upper and lower margins, sides defining a periphery of the cabinet, and an access door located in a first of the sides of the cabinet, the anti-theft device comprising:
means for securing the anti-theft device to the periphery of the cabinet;
means for preventing the anti-theft device from being laterally and vertically removed from the cabinet; and
releasable means for selectively allowing and preventing access to the interior of the cabinet through the door located on the first side of the cabinet.

2. The anti-theft device according to claim 1, wherein the securing and preventing means comprise:
first and second frame units, each of the frame units comprising a pair of legs and at least a first cross-member joined and oriented transverse to the pair of legs; and
at least a second cross-member that couples the first and second frame units together.

3. The anti-theft device according to claim 2, wherein the releasable means comprises:
the second cross-member, the second cross-member having a first end pivotably coupled to the first frame unit and a second end releasably coupled to the second frame unit; and
means for locking the second end of the second cross-member to the second frame unit.

4. The anti-theft device according to claim 2, wherein the first cross-member is adapted for being positioned beneath a fuel nozzle carriage of the cabinet to prevent the anti-theft device from being lifted off the cabinet.

5. The anti-theft device according to claim 2, wherein the first cross-member is adapted for engaging the lower margin of the cabinet to prevent the anti-theft device from being lifted off the cabinet.

6. The anti-theft device according to claim 1, wherein the anti-theft device is installed on the cabinet.

7. The anti-theft device according to claim 2, wherein the anti-theft device is installed on the cabinet.

8. The anti-theft device according to claim 7, wherein the first cross-member is positioned beneath a fuel nozzle carriage of the cabinet to prevent the anti-theft device from being lifted off the cabinet.

9. The anti-theft device according to claim 7, wherein the first cross-member is engaged with the lower margin of the cabinet to prevent the anti-theft device from being lifted off the cabinet.

10. A method of securing and preventing access to the components within the interior of the cabinet by installing the anti-theft device of claim 1 on the cabinet.

11. The method according to claim 10, wherein the method comprises:
securing the anti-theft device to the periphery of the cabinet;
preventing the anti-theft device from being laterally and vertically removed from the cabinet; and
selectively allowing and preventing access to the interior of the cabinet through the door located on the first side of the cabinet.

12. The method according to claim 11, wherein the securing and preventing steps are performed by a frame assembly comprising:
first and second frame units, each of the frame units comprising a pair of legs and at least a first cross-member joined and oriented transverse to the pair of legs; and
at least a second cross-member that couples the first and second frame units together.

13. The method according to claim 12, wherein the allowing and preventing step is performed by a releasable means comprising:
the second cross-member, the second cross-member having a first end pivotably coupled to the first frame unit and a second end releasably coupled to the second frame unit; and
means for locking the second end of the second cross-member to the second frame unit.

14. The method according to claim 12, further comprising positioning the first cross-member beneath a fuel nozzle carriage of the cabinet to prevent the anti-theft device from being lifted off the cabinet.

15. The method according to claim 12, further comprising engaging the first cross-member with the lower margin of the cabinet to prevent the anti-theft device from being lifted off the cabinet.

16. A method of securing and preventing access to components within an interior of a fuel dispenser cabinet having upper and lower margins, sides defining a periphery of the cabinet, and an access door located in a first of the sides of the cabinet, the method comprising:
securing an anti-theft device to the periphery of the cabinet;
preventing the anti-theft device from being laterally and vertically removed from the cabinet; and
selectively allowing and preventing access to the interior of the cabinet through the door located on the first side of the cabinet.

17. The method according to claim 16, wherein the securing and preventing steps are performed by a frame assembly comprising:
first and second frame units, each of the frame units comprising a pair of legs and at least a first cross-member joined and oriented transverse to the pair of legs; and
at least a second cross-member that couples the first and second frame units together.

18. The method according to claim 17, wherein the allowing and preventing step is performed by a releasable means comprising:
the second cross-member, the second cross-member having a first end pivotably coupled to the first frame unit and a second end releasably coupled to the second frame unit; and
means for locking the second end of the second cross-member to the second frame unit.

19. The method according to claim 17, further comprising positioning the first cross-member beneath a fuel nozzle carriage of the cabinet to prevent the anti-theft device from being lifted off the cabinet.

20. The method according to claim 17, further comprising engaging the first cross-member with the lower margin of the cabinet to prevent the anti-theft device from being lifted off the cabinet.
